(19) United States
(12) Patent Application Publication
(10) Pub. No.: US 2002/0019946 A1
(43) Pub. Date: Feb. 14, 2002

(54) Inspection method and system

(76) Inventor: Keiichi Iwamura, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/901,684

(22) Filed: Jul. 11, 2001

(30) Foreign Application Priority Data
Jul. 13, 2000 (JP) 2000-213204

(51) Int. Cl. G06F 11/30

(52) U.S. Cl. 713/201; 709/224

(57) ABSTRACT

Provides an inspection method and system which can efficiently and securely protect copyrights. To accomplish this, an inspection method inspects information stored in a terminal (104) that is included in a network (103), uses a robot agent (102) which moves between the terminals (104) and checks if a digital watermark is embedded in the information.

### FIELD OF THE INVENTION

The present invention relates to an inspection method and system for inspecting information such as moving image data, still image data, audio data, computer data, computer programs, and the like.

### BACKGROUND OF THE INVENTION

In recent years, computers and networks have developed remarkably, and various kinds of information such as text data, image data, audio data, and the like are used in computers and networks. Hence, contents businesses that trade so-called digital contents such as digital still images, moving images, music, and the like have been active.

Since information to be traded by the contents businesses is digital data, copies can be easily formed. As a method of protecting the copyright of such data, a method of embedding copyright information or user information as a digital watermark in data is known. Note that the digital watermark is a concept including every processes applied to data as productions to protect their copyrights, and is user identification information embedded without influencing the contents of the data.

By extracting the digital watermark from data, identification information of a proprietor, user, or the like can be obtained. Hence, when it is proved that user B uses image data embedded with a digital watermark indicating given user A, user A and/or user B may have illicitly copied or used the data.

The digital watermarking can be roughly classified into a method of embedding in the spatial domain and a scheme of embedding in the frequency domain, and various methods using these technologies are known.

Examples of the method of embedding in the spatial domain include an IBM scheme (W. Bender, D. Gruhl, & N. Morimoto, “Techniques for Data Hiding”, Proceedings of the SPIE, San Jose Calif., USA, February 1995), G. B. Rhoads & W. Linn, “Steganography methods employing embedded calibration data”, U.S. Pat. No. 5,636,292, and the like, which employ patchwork.

Examples of the method of embedding in the frequency domain include an NTT scheme (Nakamura, Ogawa, & Takashima, “A Method of Watermarking in Frequency Domain for Protecting Copyright of Digital Image”, SCIS' 97-26A, January 1997), which exploits discrete cosine transformation, a scheme of National Defense Academy of Japan (Onishi, Oka, & Matsui, “A Watermarking Scheme for Image Data by PN Sequence”, SCIS' 97-26B, January 1997) which exploits discrete Fourier transformation, and a scheme of Mitsubishi and Kyushu University (Ishizuka, Sakai, & Sakurai, “Experimental Evaluation of Steganography Using Wavelet Transform”, SCIS' 97-26D, January 1997) and a Matsushita scheme (Inoue, Miyazaki, Yamamoto, & Katsura, “A Digital Watermark Technique based on the Wavelet Transform and its Robustness against Image Compression and Transformation”, SCIS' 98-3.2.A, January 1998) last two of which exploit discrete wavelet transformation, and the like.

Also, systems for inspecting illegal copies exploiting the digital watermarking technique have been proposed by U.S. Pat. No. 5,862,260 (Digimarc Corporation), and Japanese Patent Laid-Open Nos. 11-39263 and 11-66009 (NTT).

These digital watermarking techniques are used under the condition that their algorithms are completely kept secret when they are used for commercial purpose (such digital watermarking system is called a secret key system). Security of digital watermarking is maintained assuming that information which pertains to the algorithm and the embedding location of information is secret. When such secret information leaks, a user who plots to illicitly distribute contents analyzes the acquired information to specify a digital watermark, and destroys information (copyright information, user information, or the like) that proves unauthorized use by modifying that portion, thus escaping from being punished.

However, the conventional copyright protection technique is inefficient and less secure. For example, a secret key digital watermarking system takes various measures to prevent the algorithm from leaking. As a result, the inspection load is heavy, it is difficult to standardize such system, and it is hard to prove unauthorized use.

### SUMMARY OF THE INVENTION

The present invention has been made to solve these problems, and has as its object to provide an inspection method and system that can efficiently and securely protect copyrights.

In order to achieve the above object, a first aspect of an inspection method according to the present invention, for inspecting information stored in terminals that are included in a network, comprises the step of:

using a program module which moves between the terminals and checks if a digital watermark is embedded in the information.

When the program module determines that a digital watermark is embedded in the information, the information is downloaded from the terminal to an inspection server.

When the program module determines that the digital watermark is embedded in the information, the program module then checks, based on the digital watermark, if a user of the terminal is an authentic user of the information.

In order to achieve the above object, a first aspect of an inspection system according to the present invention comprises an inspection host for moving a program module, which checks if a digital watermark is embedded in information stored in a terminal, between terminals that are included in a network.

In order to achieve the above object, a recording medium according to the present invention stores a program module which moves between terminals that are included in a network and checks if a digital watermark is embedded in information stored in the terminal.

In order to achieve the above object, a second aspect of an inspection method according to the present invention, comprising:

a step of disclosing a digital watermark extraction technique on a network;a step of installing the digital watermark extraction technique in a terminal which desires the installation of the digital watermark extraction technique; and an inspection step of inspecting authenticity of information in the terminal using the digital watermark extraction technique installed in the terminal.

The inspection method further comprising a step of informing, when illicit use of information is detected in the inspection step, a copyright protection terminal of the detection via the network.

A third aspect of an inspection method according to the present invention, comprises:

a step of disclosing a digital watermark extraction technique on a network;

a step of licensing a terminal which is included in the network to use the digital watermark extraction technique;

a step of installing the digital watermark extraction technique in another terminal via the use-licensed terminal; and

an inspection step of inspecting authenticity of information in the other terminal using the digital watermark extraction technique installed in the other terminal.

The method further comprises the step of informing, when illicit use of information is detected in the inspection step, a copyright protection terminal of the detection via the network.

A second aspect of an inspection system according to the present invention comprises a digital watermarking technique server which discloses a digital watermark extraction technique on a network, and licenses a terminal on the network to use the digital watermark extraction technique.

A fourth aspect of an inspection method according to the present invention comprises:

an accept step of accepting a purchase application of information via a network;

a presentation step of presenting a technique used to protect a copyright of the information via the network;

a providing step of providing the information to the user when an agreement with the technique of the user who applied for purchase of the information is confirmed; and

an inspection step of inspecting authenticity of the information using the technique.

The presentation step includes a step of presenting a measure to be taken against the user who illicitly used the information.

The presentation step includes a step of presenting to the user an extraction program which gives an explanation about a digital watermark extraction method, and can inspect digital watermark embedded in the information, and

The providing step includes a step of embedding the user identification information in the information as a digital watermark and providing that information to the user, when a user identification information is confirmed together with the agreement.

A third aspect of an inspection system according to the present invention comprises an information vendor server which accepts a purchase application of information from a user via a network, presents a technique used to protect a copyright of the information to the user via the network, and obtains a user's agreement for the technique as a sales condition of the information.

An inspection method according to the present invention comprises:

a storage medium providing step of providing a storage medium which stores enciphered information embedded with storage medium identification information as a digital watermark;

a presentation request step of requesting the user to present the storage medium identification information and user identification information;

a providing step of providing a decipher program of the enciphered information to the user in the presence of the presentation; and

an inspection step of inspecting authenticity of information by comparing the user identification information associated with the storage medium identification information embedded as the digital watermark in the information, and user information of a terminal that stores the information.

In an inspection system that sells enciphered information which is stored in a storage medium and is embedded with storage medium identification information as a digital watermark,

the system provides decipher software of the enciphered information to a user when the user presents the storage medium identification information and user identification information,

manages the storage medium identification information and user identification information in correspondence with each other, and

inspects authenticity of information by comparing the user identification information associated with the storage medium identification information embedded as the digital watermark in the information, and user information of a terminal that stores the information.

Other features and advantages of the present invention will be apparent form the following description taken in conjunction with the accompanying drawings, in which like reference characters designate the same or similar parts throughout the figures thereof.

### BRIEF DESCRIPTION OF THE DRAWINGS

FIG. 1 is a block diagram for explaining an outline of a system according to the first embodiment of the present invention;

FIG. 2 is a block diagram for explaining an outline of an agent of the first embodiment;

FIG. 3 is a flow chart for explaining an outline of the processing sequence of the system of the first embodiment;

FIG. 4 is a block diagram for explaining an outline of a system of the second embodiment;

FIG. 5 is a block diagram for explaining an outline of a system of the second embodiment;

FIG. 6 is a block diagram for explaining an outline of a system of the third embodiment;

FIG. 7 is a flow chart for explaining an outline of the processing sequence of the system of the third embodiment;

FIG. 8 is a block diagram for explaining the internal arrangement of a terminal;

FIG. 9 is a flow chart for explaining an outline of the processing sequence of the system of the third embodiment;

FIG. 10 is a flow chart for explaining an outline of the processing sequence of the system of the third embodiment;

FIG. 11 is a block diagram for explaining an outline of a system of the fourth embodiment;

FIG. 12 is a flow chart for explaining an outline of the processing sequence of the system of the fourth embodiment;

FIG. 13 is a block diagram for explaining an outline of a system of the fifth embodiment; and

FIG. 14 is a flow chart for explaining an outline of the processing sequence of the system of the fifth embodiment.

### DETAILED DESCRIPTION OF THE PREFERRED EMBODIMENTS

Preferred embodiments of the present invention will be explained in detail hereinafter with reference to the accompanying drawings. Note that the relative layout of building components, equations, numerical values, and the like described in the embodiments do not limit the scope of the present invention to themselves unless otherwise specified.

(First Embodiment)

An unauthorized use inspection system of digital contents will be explained as the first embodiment of an information processing system according to the present invention.

In this system, an agent having a digital watermark extraction function moves on the network (mobility) to extract a digital watermark at each terminal that is included in the network. The digital contents is checked based on the extraction result (intelligence), and the checking result is sent to an inspection station (communication), thereby inspecting unauthorized use of digital contents.

The inspection system disclosed in U.S. Pat. No. 5,862,260 and Japanese Patent Laid-Open Nos. 11-39263 and 11-66009 are based on thepremise that not a user terminal but an inspection station which keeps secret of information executes the extraction process to maintain the confidentiality of information that pertains to a digital watermark. That is, the contents of a user terminal that can be accessed on the network are downloaded to the inspection station, which executes a digital watermark extraction process and checks if the contents are illicitly used.

Therefore, in the conventional inspection system disclosed in U.S. Pat. No. 5,862,260 and Japanese Patent Laid-Open Nos. 11-39263 and 11-66009, all accessible contents must be downloaded to the inspection station to implement perfect inspection, and the communication volume and cost required therefor become huge. In addition, since all contents are concentrated on one or a few inspection stations, the load on the inspection station or stations is heavy.

By contrast, this embodiment runs a robot agent on the network to check at each terminal if a digital watermark is embedded in the contents possessed by the terminal, and to download only information embedded with a digital watermark to the inspection station. In this way, the communication volume required for downloading can be greatly reduced, and concentration of information on the inspection station can be relaxed.

An agent will be briefly explained below. The agent is a generic name of a technology which makes a virtual entity execute an information process in place of a human being. The ability of the agent can be roughly classified into three: “intelligence”, “communication”, and “mobility”.

“Intelligence” is the ability that pertains to troubleshooting of an individual agent. The agent must infer or plan to some extent to determine its own course of action in various situations. A poor intelligent agent cannot execute a process corresponding to a change in situation, and can only take an action in response to an input from the user or another system as a trigger. On the other hand, a think-over type agent that determines an action as a result of complicated inference and planning may miss an opportunity of an action to be taken. That is, “intelligence” includes not only the ability of inference or planning but also that of keeping good balance with quick response.

“Communication” is the ability of an agent that exchanges information with another agent and requests to execute a task. This ability is an indispensable technique in a multi-agent system in which a plurality of agents work in collaboration. How to detect a user's request and how to represent the progress of the current work of the agent to the user are matters of “communication” of the agent. Such matters are very important upon designing a user interface of the agent system.

“Mobility” is the ability that the agent changes a computer environment where it works. This is an essential technique for a mobile agent that moves on the network in search for a required computation resource. A given agent may solve a problem by communicating with a required resource and an agent that manages it in some cases, but it may had been better to execute an information process by itself by moving to a machine having that resource. “Mobility” gives such degree of freedom in action to the agent.

An outline of the agent has been explained, and details of the agent are described in “Special Issue: Latest Agent Technology” (bit February 1999/Vol.31, No. 2, pp. 2-34) and the like.

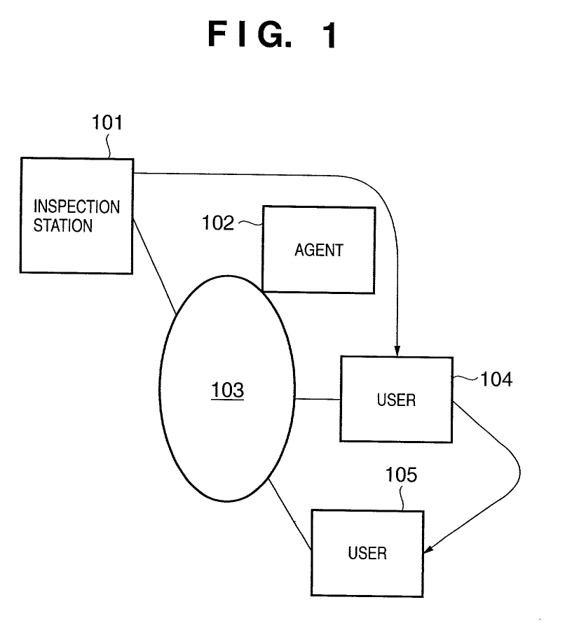

FIG. 1 shows an outline of an unauthorized use inspection system of this embodiment.

Reference numeral 101 denotes an inspection station that generates an agent 102 to monitor unauthorized use of digital contents, and is connected to a network 103. Reference numerals 104 to 105 denote user terminals connected to the network 103. The network 103 can be the Internet or the like.

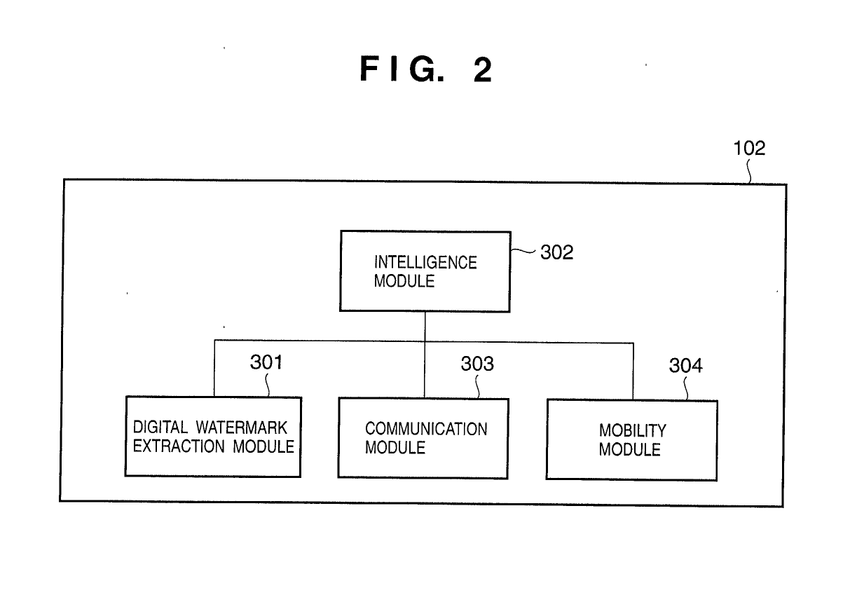

The agent 102 has an internal arrangement shown in FIG. 2, and a digital watermark extraction module 301, a communication module 303 that communicates with another agent, the terminal, or the inspection station, a mobility module 304 that moves to the inspection station or among the user terminals are controlled by an intelligence module 302.

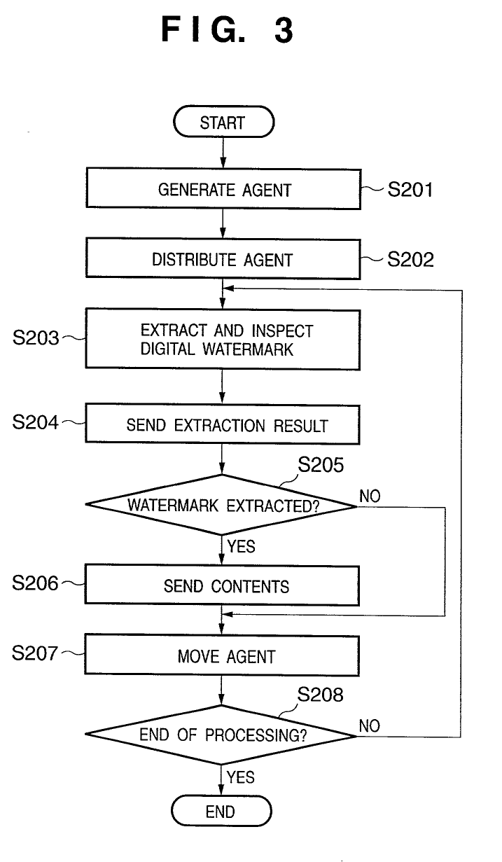

The flow of the process in this system will be explained below using the flow chart shown in FIG. 3.

The inspection station 101 generates the agent 102 (step S201), and moves it using the network 103 (step S202). The agent 102 moves to the user terminal 104, inspects accessible digital contents in that terminal using the digital watermark extraction module 301 (step S203), and sends the inspection result and user name to the inspection station 101 using the communication module 303 (step S204). In this case, if a digital watermark is extracted from the inspected digital contents (step S205), the agent sends the contents to the inspection station (step S206). If no digital watermark is extracted from the inspected digital contents (step S205), the agent determines that no unauthorized use is found, and does not send any contents. After all contents are inspected, the agent 102 moves to the next user terminal 105 (step S207) to repeat the operations in step S203 and subsequent steps for accessible digital contents in that terminal. If an end condition such as the number of user terminals to be inspected, an end time, or the like is satisfied (step S207), the agent 102 moves to the inspection station 101, thus ending the process.

As described above, according to this embodiment, since the agent inspects a digital watermark in place of sending all digital contents to the inspection station, and sends only contents from which the digital watermark is extracted, the communication volume and cost are low. The inspection station need only inspect using the digital watermark information if the user who uses the contents is authentic, thus reducing the load on the inspection station. By setting higher intelligence to the agent, the agent may analyze the digital watermark information extracted in step S205 and that user terminal. If the agent determines that the user is authentic, it may not send any contents; otherwise, it may send contents. As a result, the communication volume and cost can be further reduced, and the load on the inspection station can be lightened. Hence, the inspection station can concentrate on, e.g., a process for generating a warning to such unauthorized user, and deterring such user from unauthorized use.

If contents that cannot be discriminated by the agent are present, uncertainty can be eliminated when such contents are also sent to the inspection station.

On the other hand, a digital watermarking scheme that can disclose the digital watermarking algorithm, the embedded position of digital watermark information, and the like is disclosed in Japanese Patent Laid-Open No. 11-289255. According to this scheme, since the entire digital contents are encoded by error correction coding, even when embedded information at the public position is destroyed, embedded information can be recovered from the entire contents. Since error correction is made independently of the digital watermarking algorithm, the digital watermarking algorithm can also be disclosed. The digital watermarking scheme that can disclose the algorithm and embedded position will be referred to as a public key digital watermarking scheme.

Using this scheme that can disclose the algorithm and digital watermark embedded position, even when the digital watermark extraction module built in the agent is analyzed by the user terminal or even when the analyzed digital watermark position is destroyed, information can be securely recovered.

(Second Embodiment)

The first embodiment has exemplified the system in which inspection is done by one inspection station and one agent. This embodiment will explain a system in which inspection is done by one or a plurality of inspection stations and a plurality of agents.

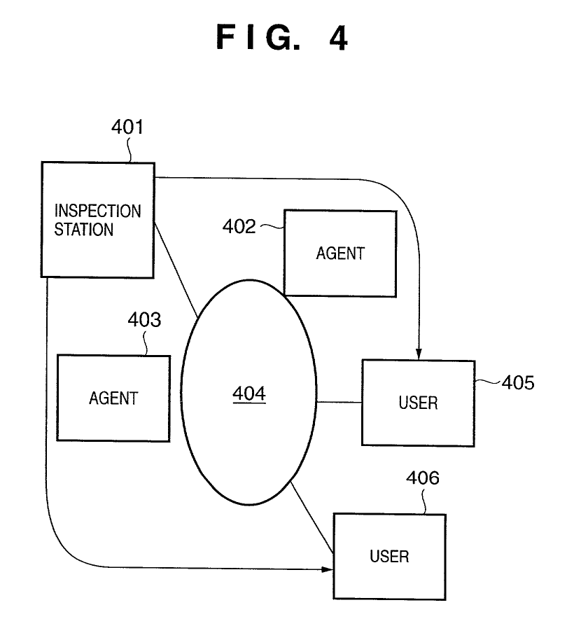

FIG. 4 shows a system in which inspection is done by one inspection station and a plurality of agents.

An inspection station 401 generates a plurality of agents 402 and 403, and inspects digital contents on user terminals 405 and 406 via a network 404. The building components of the system are substantially the same as those of the first embodiment except for the following difference.

The inspection station 401 programs and controls the shares of the agents in their intelligence modules to prevent the agents from inspecting an identical user terminal. For example, when the agent 402 covers terminals with an organization identifier “co” in their URLs, and the agent 403 covers terminals with an organization identifier “ne”, they can share their respective organizations. In this manner, one inspection station can inspect a plurality of terminals at the same time, thus remarkably improving inspection efficiency.

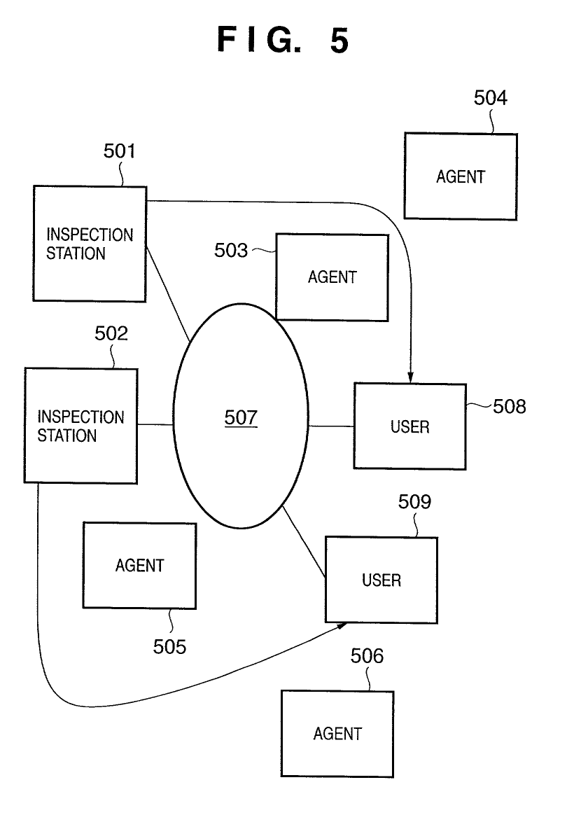

FIG. 5 shows a system in which inspection is done by a plurality of inspection stations and a plurality of agents.

Reference numerals 501 and 502 denote a plurality of inspection stations, which generate a plurality of agents 503 to 506 and inspect digital contents on user terminals 508 and 509 via a network 507. In this system, the plurality of inspection stations operate the system of FIG. 4 independently or in collaboration. Such system is effective when the processing cannot be covered by one inspection station due to different copyright protection criteria for respective countries. On the other hand, inspection stations may operate for respective areas.

(Third Embodiment)

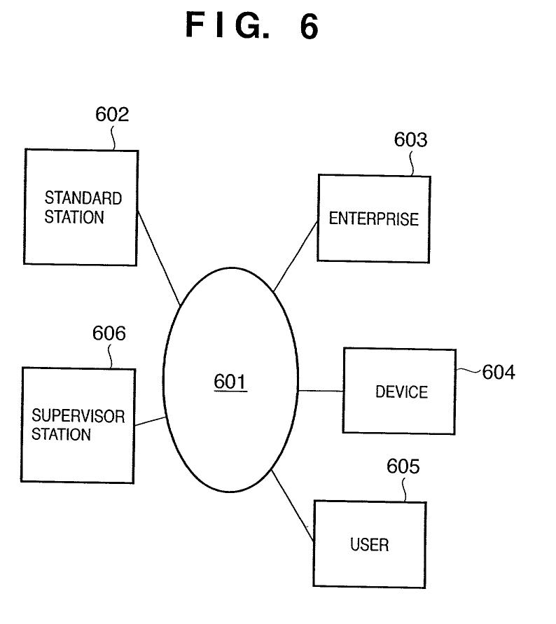

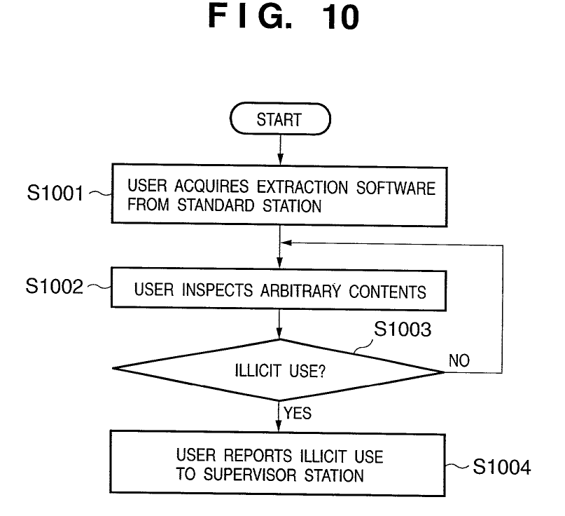

The third embodiment of the present invention will be described below using FIGS. 6 to 10.

This embodiment relates to a system which allows many terminals to install digital watermarking means using the public key digital watermarking technique even when no specific management station is present.

FIG. 6 is a schematic diagram showing the arrangement of an information processing system of this embodiment.

Reference numeral 601 denotes a network such as the Internet or the like; 602, a terminal of a standard station which is connected to the network 601 and discloses the digital watermarking method; 603, a terminal of an enterprise/organization/individual (to be generally referred to as an enterprise hereinafter), which is connected to the network 601 and installs a digital watermarking scheme; 604, a device which is connected to the network 601, is installed with the digital watermarking scheme by the enterprise 603, and is purchased by the user; 605, a user terminal which is connected to the network 601, and in which software or the like can be externally installed; and 606, a terminal of a supervisor station which is connected to the network 601 and supervises unauthorized use of digital contents.

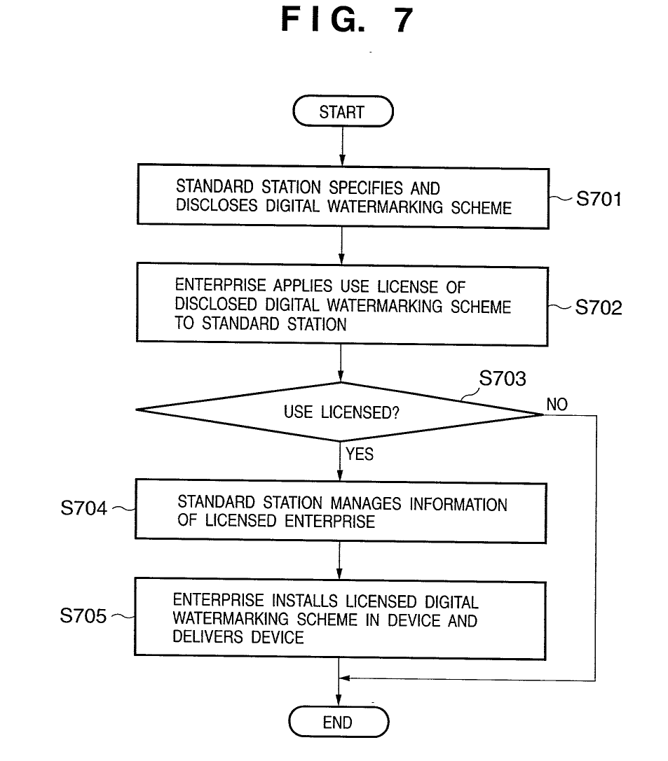

FIG. 7 is a flow chart showing the flow of the process of this information processing system.

The standard station 602 discloses information such as the algorithm, use condition, and the like of a predetermined digital watermarking scheme on the network 601 using a home page or the like (step S701). Note that the home page or the like presents the use license procedure and the like of a digital watermark. Alternatively, detailed information may be downloadable from the home page or the like. In this case, the public information may contain all pieces of information required for installing a digital watermark in a device or some pieces of information which are segmented so that all the pieces of information can be acquired after license screening. In case of segmented information, the remaining pieces of information are sent after license screening.

The enterprise/organization/individual 603 who wants to use a digital watermarking method applies to the standard station 602 for a use license of that method via the network 601 or in accordance with the procedure designated by the standard station 602 (step S702).

In case of application via the network, an application form can be downloaded from the standard station 602, and the enterprise 603 downloads that form and sends it back to the standard station 602 via the network after designated blanks are filled. Alternatively, the home page of the standard station 602 may publish a file for an application form, and the enterprise 603 may input required information via the network. Then, it is screened if the enterprise 603 satisfies the license condition of the standard station 602 (step S703). This screening may be done by an automatic flow chart or the like determined by the standard station 602. The flow ends if use is not licensed.

If use is licensed, the standard station 602 saves and manages enterprise information obtained in the application process from the enterprise 603 or licensing process in a database (step S704). The enterprise 603 stores a licensed digital watermarking extraction program in the device 604 (step S705).

If all pieces of information that pertain to installation of a digital watermarking scheme is disclosed in step S701, the application/licensing/management processes in steps S702 to S704 may be omitted. The terminals and device 602 to 606 may be implemented by general computers. The device 604 may be a dedicated device such as a printer, scanner, or the like.

According to this embodiment, a system that can license use of the digital watermarking scheme without any non-disclosure agreement can be built. With this system, since an identical digital watermarking scheme is applied to many devices manufactured by the enterprise, a system having a standard digital watermarking scheme can be built.

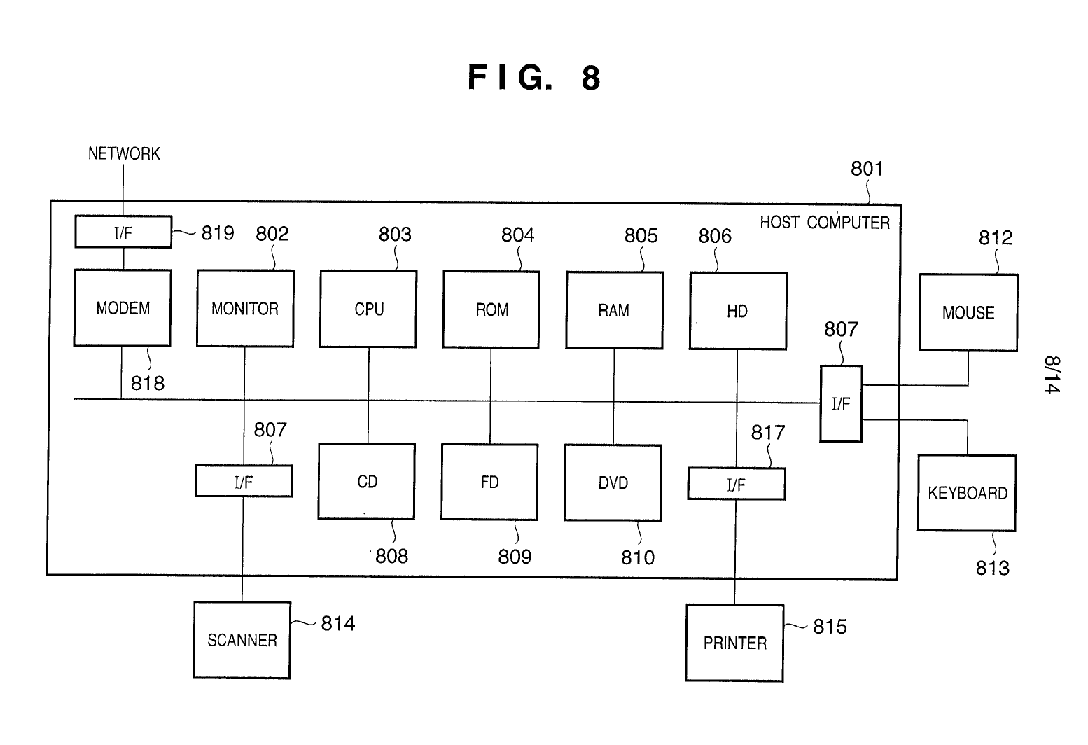

FIG. 8 shows an example of the hardware arrangement of the terminal.

A host computer 801 is, e.g., a generally prevalent personal computer, and can receive, edit, and save an image scanned by a scanner 814. Also, the image obtained by the host computer 801 can be printed by a printer 815. The user can input various manual instructions and the like by a mouse 812 and keyboard 813.

In the host computer 801, respective blocks to be described below are connected via a bus 816 to exchange various data.

Reference numeral 803 denotes a CPU which can control the operations of the respective internal blocks, or can execute an internally stored program.

Reference numeral 804 denotes a ROM which stores a specific image which is inhibited from being printed, a required image processing program, and the like.

Reference numeral 805 denotes a RAM which temporarily stores a program and image data to be stored upon executing a process by the CPU.

Reference numeral 806 denotes a hard disk (HD) which can pre-store a program and image data transferred to the RAM or the like and can save processed image data.

Reference numeral 807 denotes a scanner interface (I/F) which connects a scanner for scanning a document, film, or the like using a CCD to generate image data, and can receive image data obtained by the scanner.

Reference numeral 808 denotes a CD drive which can read or write data from or to a CD (CD-R) as one of external storage media.

Reference numeral 809 denotes an FD drive which can read or write data from or to an FD like the CD drive 808. Reference numeral 810 denotes a DVD drive which can read or write data from or to a DVD like the CD drive 808. When the CD, FD, DVD, or the like stores an image edit program or printer driver, such program is installed on the HD 806, and is transferred to the RAM 805 as needed.

Reference numeral 811 denotes an interface (I/F) which is connected to the mouse 812 and keyboard 813 to accept an instruction input by them.

Reference numeral 818 denotes a modem which is connected to an external network via an interface (I/F) 819.

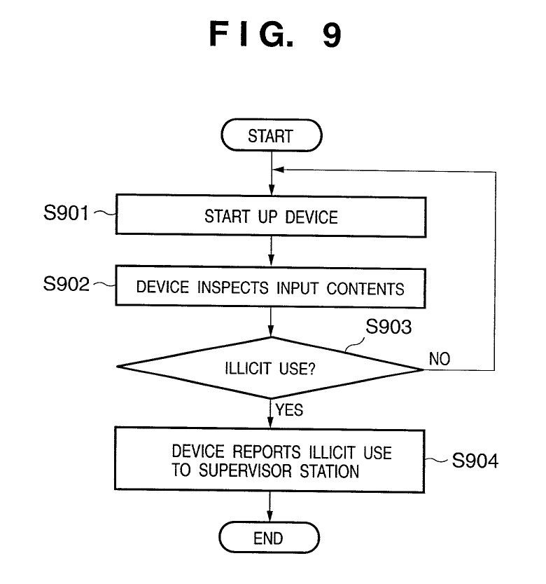

The operation of the device, purchased by the user, will be explained below using the flow chart in FIG. 9.

The delivered device 604 is purchased by the user, who connects the device 604 to the network 601 and starts it up (step S901). The started device 604 automatically inspects input contents by a digital watermark extraction means installed therein (step S902). The input contents may be either digital contents or printed contents if the device is a scanner or the like. The device 604 analyzes extracted digital watermark information to check if the contents are illicitly used (step S903). If illicit use is found, the device 604 reports it to the supervisor station 606 via the network 601 (step S904). If it is determined that the contents are illicitly used, not only illicit use is reported in step S904 but also a process for stopping the operation of the device may be done. If the digital watermark information contains the URL or the like of the supervisor station 606, a process for automatically linking to the supervisor station may be done. If no illicit use is found, the next contents are inspected without reporting.

Even when the digital watermark extraction method is not installed in the device 604, an unauthorized use inspection system can be built as follows.

The user terminal 605 downloads digital watermark extraction software published by the standard station 602 (step S1001). Note that the standard station may create digital watermark extraction software on the basis of the public digital watermarking algorithm, or the enterprise may develop such software by itself and disclose it under a license of the standard station. The user terminal 605 inspects arbitrary contents using the downloaded digital watermark extraction software (step S1002). The contents to be inspected are those which the user terminal 601 can access via the network 601. When the user terminal has a scanner or the like, printed contents may be inspected. The user terminal 605 analyzes the extracted digital watermark information, and checks if the contents are illicitly used (step S1003). If illicit use is found, the user terminal 605 reports it to the supervisor station 606 via the network 601 (step S1004). If no illicit use is found, the user terminal 605 does not report. If the digital watermark information contains the URL or the like of the supervisor station 606, a process for automatically linking to the supervisor station may be done.

Note that the system that uses public key digital watermarking has been explained. However, even when a secret key digital watermarking technique, which is premised on that the algorithm or embedded position is kept in secret is used, a system having the same effect as in this embodiment can be built as long as it is hard to analyze a digital watermark. Hence, this embodiment includes all systems that distribute digital contents on the user terminal side irrespective of public key digital watermarking or secret key digital watermarking.

According to this embodiment, a system that allows use application/licensing via a network using a digital watermarking scheme that can disclose the embedded position of an algorithm or digital watermark can be built. With this system, since an identical digital watermarking scheme is installed in many devices, a system having a standard digital watermarking scheme can be built. Also, a system which can efficiently inspect unauthorized use by exploiting the standard digital watermarking scheme can be built.

(Fourth Embodiment)

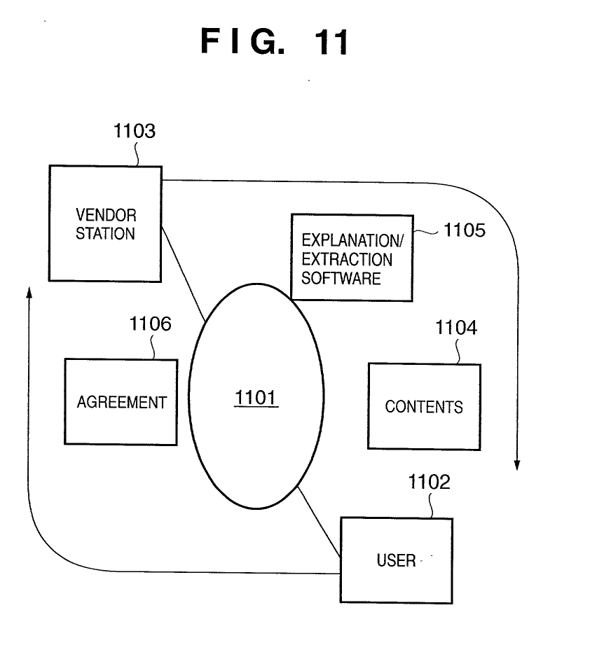

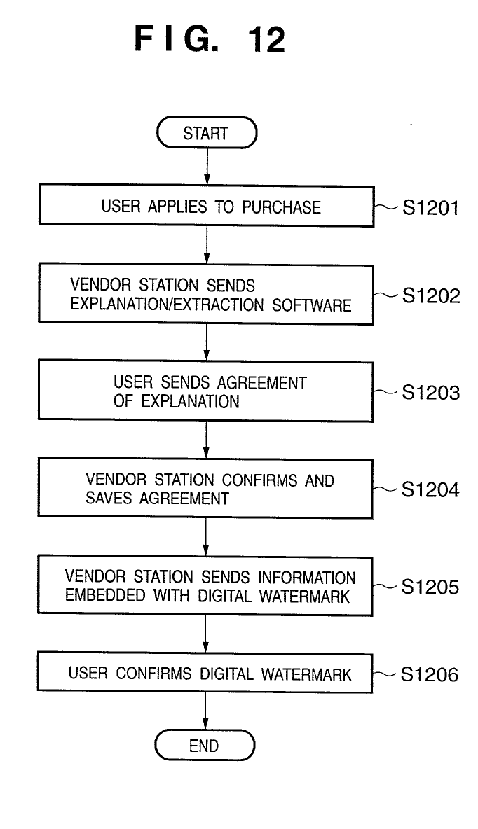

The fourth embodiment of the present invention will be described below using FIGS. 11 and 12.

This embodiment relates to a system which explains the principle and algorithm of the digital watermarking technique on the network using a pubic key digital watermarking technique, and obtains a user's agreement via the network so as not to allow a user accused of unauthorized use to deny of such crime.

FIG. 11 is a schematic diagram showing the arrangement of a system of this embodiment.

Reference numeral 1101 denotes a network such as the Internet or the like; 1102, a user terminal such as a PC or the like connected to the network 1101; 1103, a vendor station which is connected to the network 1101, and sells digital contents and embeds a digital watermark in accordance with an order from the user; 1104, digital contents which are purchased by the user 1102 and are embedded with the ID or the like of that user as a digital watermark; 1105, software that explains the use condition of the digital contents 1104, digital watermarking scheme, and the like, and extracts digital watermark information; and 1106, a user's agreement file for information (the use condition of contents, a measure taken against unauthorized use, the digital watermark extraction method, and the like) confirmed by the software 1105.

The operation of this system will be explained below using the flow chart shown in FIG. 12.

The user 1102 applies for purchase of digital contents to the vendor station 1103 via the network 1101 (step S1201). The vendor station 1103 sends to the user 1102 the extraction software 1105 that can give an explanation about the use condition of the contents, a measure taken against unauthorized use, and the digital watermark extraction method, and can inspect the embedded digital watermark information (step S1202). The digital watermark extraction software may include sample contents for tryout. The user understands the explanation using the received explanation/extraction software 1105, creates an agreement 1106, and sends it to the vendor station 1103 (step S1203). The agreement may be automatically created and sent by the explanation/extraction software 1105 except for some inputs by the user. The vendor station 1103 confirms and saves the agreement 1106 (step S1204). Furthermore, the vendor station 1103 embeds a digital watermark such as a user ID or the like in the contents 1104 for the purchase of which the user applied, and sends the contents 1104 to the user 1102 (step S1205). The user 1102 inspects the received contents 1104 using the explanation/extraction software 1105, and confirms the digital watermark information.

When the user cannot inspect the digital watermark of the contents 1104 using the explanation/extraction software 1105, or extracts a digital watermark with wrong contents, he or she can return the contents 1105 and extraction software 1105 within a predetermined period after the contents sales as a cooling-off period. Hence, the user cannot make a false compliant unless he or she destroys or tampers with the digital watermark within that period.

The user 1102 preferably affixes a digital signature or the like based on a public key certificate to an application and agreement. The public key certificate is data which is issued by a credible third party organization called an authentication station, and contains an identification name (a name for specifying an individual) and a public key of that user signed by the authentication station. By affixing the signature of the authentication station, the contents can be prevented from being tampered with, and the user who received the certificate can verify that the public key in the certificate is that of the applied user by accrediting the authentication station. That is, the public key and the user (or server) of the real world are securely bound.

The steps of creating, confirming, and saving an agreement may be omitted. In this case, since it is a matter of common knowledge that an explanation which pertains to copyright protection including a digital watermark has been given using the explanation/extraction software although no user's agreement is present, authenticity of the user and third party when illicit use is discovered is high compared to a conventional system that does not explain about copyright protection such as the digital watermarking scheme or the like.

(Fifth Embodiment)

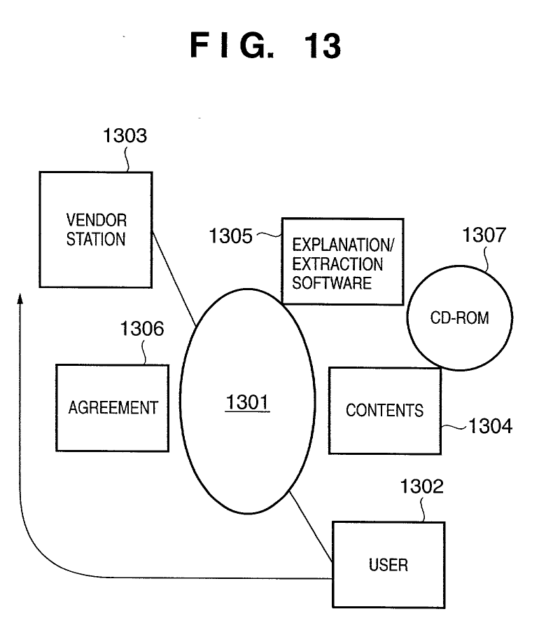

The fifth embodiment of the present invention will be described below using FIGS. 13 to 15.

The fourth embodiment relates to a network vendor system of contents, while this embodiment relates to a contents vendor system via CD-ROMs or the like.

FIG. 13 is a schematic diagram of a system of this embodiment.

Reference numeral 1301 denotes a network such as the Internet or the like; 1302, a user terminal; 1303, a vendor station that sends a decipher key of digital contents 1304 in accordance with an order from the user, and manages user data; 1304, digital contents which are stored in a CD-ROM 1307, are embedded with the CD-ROM number, contents ID, and the like as a digital watermark, and are enciphered; 1305, software that explains the use condition of the digital contents 1304, decipher method, and digital watermarking scheme, and extracts digital watermark information; 1306, a user's agreement file for information (the use condition of contents, a measure taken against unauthorized use, the digital watermark extraction method, and the like) confirmed by the software 1305; and 1307, a storage medium such as a CD-ROM or the like which is on sale in a store, and stores enciphered digital contents.

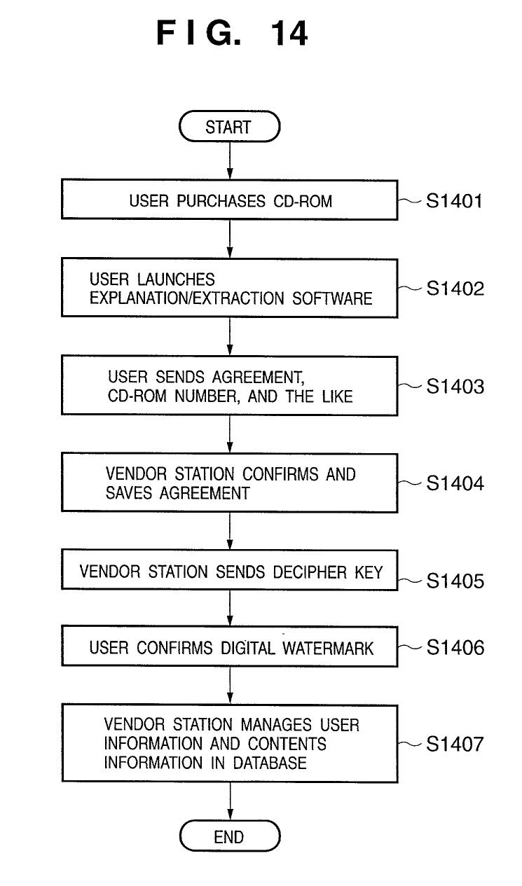

The operation of this system will be explained below using the flow chart in FIG. 14.

The user 1302 purchases the CD-ROM 1307 from a store (step S1401). The user 1302 launches the explanation/extraction software 1305 contained in the CD-ROM 1307, and is given an explanation about the use condition of the contents, a measure taken against illicit use, and the digital watermark extraction method (step S1402). The CD-ROM 1307 may store sample contents for tryout. The user 1302 understands the explanation of the explanation/extraction software 1305, creates an agreement 1306, and sends it to the vendor station 1303 together with the CD-ROM number using the network 1301 (step S1403). This agreement is preferably appended with the aforementioned digital signature. When the terminal of the user 1302 is not connected to the network, the user 1302 sends the printed agreement and CD-ROM number to the vendor station 1303 via other means such as a phone, FAX, mail, or the like. The vendor station 1303 confirms and saves the received agreement 1306 (step S1404). The vendor station sends a decipher key used to decipher the enciphered contents 1304 the purchase of which the user 1302 applied to the user 1302 via the network or designated means (step S1405). The user deciphers the contents 1304 using the received decipher key, and extracts and confirms a digital watermark using the explanation/extraction software 1305 (step S1406). Finally, the vendor station 1303 manages the CD-ROM number sent together with the agreement and the ID of the contents purchased by the user 1302 in a database in combination with user information (step S1407).

The agreement may be automatically created and sent together with the CD-ROM number except for some user's inputs upon executing the explanation/extraction software 1305. Furthermore, the explanation/extraction software 1305 may automatically decipher the enciphered contents and extract the digital watermark except for some user's inputs.

In this embodiment, the CD-ROM number and/or the contents ID are/is embedded in the contents, and the vendor station 1303 manages the CD-ROM number/contents ID in the database together with the user information, thus specifying an unauthorized user. That is, if unauthorized digital contents are found, and the CD-ROM number and/or the contents ID are/is embedded in the contents, the database can be searched using the ID to specify the user who purchased the contents.

In this embodiment as well, the steps of creating and sending an agreement may be omitted.

(Other Embodiments)

In the fourth and fifth embodiments of the present invention, the explanation/extraction software is distributed to each user. Alternatively, link information to a home page may be provided in place of distributing the software. In this case, the home page may have an explanation about the use condition of digital contents and digital watermark extraction software, and the digital watermark extraction software may be downloaded from that home page.

Furthermore, the digital watermark extraction software disclosed on the home page can be downloaded by not only the user who purchases digital contents but also all users who can access the network. Hence, when many users download the digital watermark extraction software, inspect digital contents of other user terminals they access, using the software, and report the results to the contact address on the home page via a communication function of the terminal or the like, a digital contents inspection system can be built.

Note that the present invention may be applied to either a system constituted by a plurality of devices (e.g., a host computer, an interface device, a reader, a printer, and the like), or an apparatus consisting of a single equipment (e.g., a copying machine, a facsimile apparatus, or the like).

The objects of the present invention are also achieved by supplying a storage medium, which records a program code of a software program that can implement the functions of the above-mentioned embodiments to the system or apparatus, and reading out and executing the program code stored in the storage medium by a computer (or a CPU or MPU) of the system or apparatus. In this case, the program code itself read out from the storage medium implements the functions of the above-mentioned embodiments, and the storage medium which stores the program code constitutes the present invention. The functions of the above-mentioned embodiments may be implemented not only by executing the readout program code by the computer but also by some or all of actual processing operations executed by an operating system (OS) running on the computer on the basis of an instruction of the program code.

Furthermore, the functions of the above-mentioned embodiments may be implemented by some or all of actual processing operations executed by a CPU or the like arranged in a function extension card or a function extension unit, which is inserted in or connected to the computer, after the program code read out from the storage medium is written in a memory of the extension card or unit.

When the present invention is applied to the storage medium, the storage medium stores program codes corresponding to the aforementioned flow charts.

According to the present invention, an inspection method and system that can efficiently and securely protect copyrights can be provided.

As many apparently widely different embodiments of the present invention can be made without departing from the spirit and scope thereof, it is to be understood that the invention is not limited to the specific embodiments thereof except as defined in the appended claims.

What is claimed is:

1. An inspection method for inspecting information stored in terminals that are included in a network, comprising the step of:
using a program module which moves between the terminals and checks if a digital watermark is embedded in the information.

2. The method according to claim 1, wherein when the program module determines that a digital watermark is embedded in the information, the information is downloaded from the terminal to an inspection server.

3. The method according to claim 1, wherein when the program module determines that the digital watermark is embedded in the information, the program module then checks, based on the digital watermark, if the user of the terminal is an authentic user of the information.

4. An inspection system comprising an inspection host for moving a program module, which checks if a digital watermark is embedded in information stored in a terminal, between terminals that are included in a network.

5. A recording medium that stores a program module which moves between terminals that are included in a network and checks if a digital watermark is embedded in information stored in the terminal.

6. An inspection method comprising:
a step of disclosing a digital watermark extraction technique on a network;
a step of installing the digital watermark extraction technique in a terminal which desires the installation of the digital watermark extraction technique; and
an inspection step of inspecting authenticity of information in the terminal using the digital watermark extraction technique installed in the terminal.

7. The method according to claim 6, further comprising a step of informing, when illicit use of information is detected in the inspection step, a copyright protection terminal of the detection via the network.

8. An inspection method comprising:
a step of disclosing a digital watermark extraction technique on a network;
a step of licensing a terminal which is included in the network to use the digital watermark extraction technique;
a step of installing the digital watermark extraction technique in another terminal via the use-licensed terminal; and
an inspection step of inspecting authenticity of information in the other terminal using the digital watermark extraction technique installed in the other terminal.

9. The method according to claim 8, further comprising a step of informing, when illicit use of information is detected in the inspection step, a copyright protection terminal of that detection via the network from the other terminal.

10. An inspection system comprising a digital watermarking technique server which discloses a digital watermark extraction technique on a network, and licenses a terminal which is included in the network to use the digital watermark extraction technique.

11. An inspection method comprising:
an accept step of accepting a purchase application of information via a network;
a presentation step of presenting a technique used to protect a copyright of the information via the network;
a providing step of providing the information to the user when an agreement with the technique of the user who applied for purchase of the information is confirmed; and
an inspection step of inspecting authenticity of the information using the technique.

12. The method according to claim 11, wherein the presentation step includes a step of presenting a measure to be taken against the user who illicitly used the information.

13. The method according to claim 11, wherein the presentation step includes a step of presenting to the user an extraction program which gives an explanation about a digital watermark extraction method, and can inspect digital watermark embedded in the information, and
the providing step includes a step of embedding, when identification information of the user is confirmed together with the agreement, the user identification information in the information as a digital watermark, and providing that information to the user.

14. An inspection system comprising an information vendor server which accepts a purchase application of information from a user via a network, presents a technique used to protect a copyright of the information to the user via the network, and obtains a user's agreement for the technique as a sales condition of the information.

15. An inspection method comprising:
a storage medium providing step of providing a storage medium which stores enciphered information embedded with storage medium identification information as a digital watermark;
a presentation request step of requesting the user to present the storage medium identification information and user identification information;
a providing step of providing a decipher program of the enciphered information to the user in the presence of the presentation; and
an inspection step of inspecting authenticity of information by comparing the user identification information associated with the storage medium identification information embedded as the digital watermark in the information, and user information of a terminal that stores the information.

16. An inspection system that sells enciphered information which is stored in a storage medium and is embedded with storage medium identification information as a digital watermark,
said system providing decipher software of the enciphered information to a user when the user presents the storage medium identification information and user identification information,
managing the storage medium identification information and user identification information in correspondence with each other, and
inspecting authenticity of information by comparing the user identification information associated with the storage medium identification information embedded as the digital watermark in the information, and user information of a terminal that stores the information.
